(19) United States
(12) Patent Application Publication
(10) Pub. No.: US 2010/0269242 A1
(43) Pub. Date: Oct. 28, 2010

(54) Material Structure Made of Flame-Retardant Material, Especially for Reflective Clothing

(76) Inventor: Werner Stubiger, Neubiberg (DE)

Correspondence Address: GORE ENTERPRISE HOLDINGS, INC., 551 PAPER MILL ROAD, P. O. BOX 9206, NEWARK, DE, 19714-9206, US

(21) Appl. No.: 12/682,740

(22) PCT Filed: Oct. 6, 2008
(86) PCT No.: PCT/EP2008/008425

§ 371 Date: Jul. 8, 2010

(30) Foreign Application Priority Data
Oct. 19, 2007 (DE) 10 2007 050 175.9

(51) Int. Cl. A62B 17/00; B32B 3/10

(52) U.S. Cl. 2/81; 428/195.1; 428/196

(57) ABSTRACT

A material structure (1) comprises a base structure (10) that includes, at least partially, a flame-retardant material with a first side (12) and a second side (14), at least the first side (12) of the base structure being printed with a pattern (20) that has open areas (50) through which the surface of the base structure (10) is visible. The pattern (20) has a material (30) containing a fluorescent dye (40), the visible surface of the first side (12) of base structure (10), in combination with pattern (20), producing a color of the material structure that satisfies the requirements of European standard EN 471. The material structure can be used, in particular, to produce warning and protective clothing.

The present invention relates to a material structure, especially for the production of a material web for clothing that includes, at least partially, a flame-retardant material, and can be used, in particular, to produce warning and protective clothing. The present invention also concerns a clothing article with such a material structure.

Work clothing that is highly visible, such as warning clothing, at least partially provided with a specific signal color, is required in a variety of areas. The use of signal colors especially serves the purpose that the wearer of the work clothing, in a wide variety of environmental conditions, is highly recognizable by the luminescent and color effect of the signal colors. It is also often essential that the work clothing additionally fulfill a protective function, such as flame resistance, in order to protect the wearer of the work clothing from dangerous environmental conditions, such as fire and heat. Areas of use of such warning and protective clothing are found especially in fire departments and emergency services.

Requirements on the “conspicuous” material to be used for such warning clothing are established in European standard EN 471 (2003). It is defined here, in particular, that the conspicuousness be increased by high contrast between the clothing and the background against which the clothing is seen, and by large surfaces of the established conspicuous material. For this purpose, three color ranges for background material and material with combined properties are considered. Requirements on the color behavior in the materials used are also established. For this purpose, color requirements on background material and material with combined properties are established in a color table that establishes the standard color value fractions and luminance factor for the three essential signal colors, fluorescent yellow, fluorescent orange-red and fluorescent red. In order to for warning clothing to correspond to the requirements of EN 471, its color values and luminance factor must lie within the value ranges stated in this color table.

Such warning clothing can be produced in various ways. In the first place, the material or outermost material layer of the material used to produce the warning clothing can be dyed with the signal color itself, in order to achieve a comparatively large surface coloring of the clothing with the corresponding signal color. This production method, however, is only suitable for certain materials and material compositions. In particular, material structures for heat- and flame-resistant clothing produced from specific fibers or yarns, such as aramid, which are particularly suited for fire-protective clothing, can only be dyed with signal colors with considerable difficulty or not at all with common dying methods. For this reason, warning clothing is either not available for these areas of use or we get by with auxiliary expedients, such as stitching fluorescent strips on at strategically prescribed locations of the protective clothing. Another possibility is to make certain compromises in production and color with the drawbacks of rapid yellowing of the luminescent dyes or use of a color not conforming to EN 471.

Another possibility is to keep on hand at the corresponding facilities, such as fire departments or emergency services, both protective clothing that is designed for use conditions under the influence of fire or heat, without using signal colors, and also warning clothing, such as warning vests, which meet standard EN 471 and can be used for applications, such as accident rescue, etc. However, this is relatively cost-intensive, because of the increased acquisition costs, and there are sometimes usage conditions, for example, firefighting in accident situations, in which the protective clothing must both fulfill heat- and fire-resistance and also have a warning effect.

Clothing with permanent soiling resistance is described in WO 01/66851 A and EP 1,143,062 A1, which is produced at least partly from a material that has a color meeting the requirement of European standard EN 471 in combination with a fluorescently dyed background material. The substance consists of yarn material, whereby the threads are essentially fully coated with a silicone coating, but the silicone coating does not completely fill up the intermediate spaces between the threads. On the one hand, a situation is achieved in which the protective clothing thus produced meets the requirements of EN 471 and, on the other hand, the intermediate spaces guarantee that a certain moisture transport outward is made possible, in order to increase wearing comfort. The amount of silicone material and fluorescent color pigments is chosen in such a way that the requirements established in EN 471 of the above-mentioned color table are satisfied. The surface of the individual yarns is fully enclosed by the dyed silicone material, in which case, the drawback develops that the coated material is no longer flame- or heat-resistant according to the requirements. In addition, the tacky- and stiff-feeling silicone yarn structure is not always desired.

The present invention is therefore based on the task of providing a material structure with at least partially flame-retardant material that can be used to produce warning clothing with a simultaneous protective function.

The invention concerns a material structure, especially for the production of a material web for clothing, according to the features of claim 1, as well as a clothing article with such a material structure according to the features of claim 32.

The material structure according to the invention includes a base structure that at least partially includes a flame-retardant material with a first side and a second side, whereby at least the first side of the base structure is printed with a pattern having open areas through which the surface of the base structure is visible. The pattern here has a material containing a luminescent dye, so that the surface of the first side of the base structure, in combination with the pattern, produces a color of the material structure that satisfies the requirements of European standard EN 471.

The material structure according to the invention can be used to produce flame-retardant protective clothing with a simultaneous warning function, since a signal color of the material structure can be produced with the base structure in combination with the pattern, which meets the requirements of European standard EN 471. At the same time, by means of the base structure, which includes at least partially a flame-retardant material, a flame-retardant protective effect of clothing produced with this material structure is achieved. In particular, a signal color, as required in EN 471, can be achieved in this way, which cannot be achieved for technical reasons by direct dyeing of aramid yarns or fibers.

In principle, coloring of a surface of a material structure in almost any color coordinates is possible in this way. In particular, all color values and luminance factors mentioned in the color table of EN 471 can be achieved. It is therefore unnecessary that the base structure itself meet the EN 471 requirements, since this can be achieved by applying a colored partial coating in combination with the color of the base structure. By appropriately varying the parameters color/brightness of the base structure, color/brightness of the patterned coating, and percentage coverage, in principle, any color can be set. It is advantageous if the visible side of the base structure is dyed with a light color and the pattern is designed as a covering that is colored and partially coated.

In addition, the material structure achieves a situation in which a certain moisture transport is guaranteed through the open areas of the pattern, so that wearing comfort is not essentially restricted. For a case in which the patterned coating has no or only limited water-vapor permeability, a low degree of coverage is generally sought. For example, the pattern can have a degree of coverage of approximately 20% to 80%, especially 30% to 70%, and, for example, a degree of coverage of 40% to 60% of the surface of the base structure. A typical pattern that satisfies the color requirement according to EN 471 is achieved with a honey-yellow aramid textile as base structure with a patterned fluorescent orange coating, which is formed, in particular, as a grid pattern with a degree of coverage of 60%.

In another embodiment of the invention, however, it is also possible that the pattern is designed as a grid pattern or a dot pattern. For example, the base structure can contain a yarn or a fiber that can be produced from aramid, viscose, and/or polyimide. For example, the base structure can be produced from an aramid-yarn woven, warp-knit, knit-fabric or aramid-nonwoven material, and in this way, a highly flame-retardant and heat-resistant protective effect can be guaranteed.

The material structure according to the invention can be used, in particular, to produce a clothing article, especially to produce protective clothing with a warning function, especially flame- and heat-resistant protective clothing for fire departments. Such a material structure can be used, in particular, to produce clothing or parts of clothing, such as jackets, coats, trousers, shirts, shoes, gloves, head coverings, etc.

According to one embodiment of the invention, the second side of the base structure facing away from the visible side of the base structure is connected to a waterproof, water-vapor-permeable functional layer or connected to an airtight (wind-tight), water-vapor-permeable functional layer. In this way, we obtain, in combination, flame-retardant protective clothing that is both waterproof and airtight, but permits a certain moisture transport outward through the water-vapor-permeable functional layer. The protective effect of such protective clothing is increased, on the one hand, and wearing comfort is not restricted by the additional protective effect, on the other hand.

With the material structure according to the invention, a fluorescent upper or outer material of protective clothing can be produced for firefighting personnel, for example, in which the outer material has a light-colored textile with at least one flame-retardant and heat-resistant yarn or fiber woven or knit-fabric material, and whose surface on the visible side is printed with a polymer material in a pattern that has open areas through which the surface of the visible side of the outer material is visible. The polymer material here contains bright fluorescent color pigments, which, in combination with the color of the surface of the visible side of the outer material, produce a color of the clothing article that meets the requirements of European standard EN 471.

A clothing article produced with the material structure according to the invention can also be designed to be reversible, for example, in the form of a reversible jacket, in which the side of the base structure printed with the pattern can be used both as an outer-material or inner-material part of the clothing article, depending on the application. When used as inner material, the patterned coating could act as abrasion protection against clothing worn underneath. Since very smooth surfaces can be achieved in the material structure according to the invention, additional product properties of a clothing article can be achieved, such as dirt repellence and abrasion resistance, especially based on the additional patterned coating.

Additional embodiments and modifications of the invention are stated in the dependent claims.

The invention will be explained further below with reference to the diagrams shown in the drawing, which represent embodiment examples of the present invention.

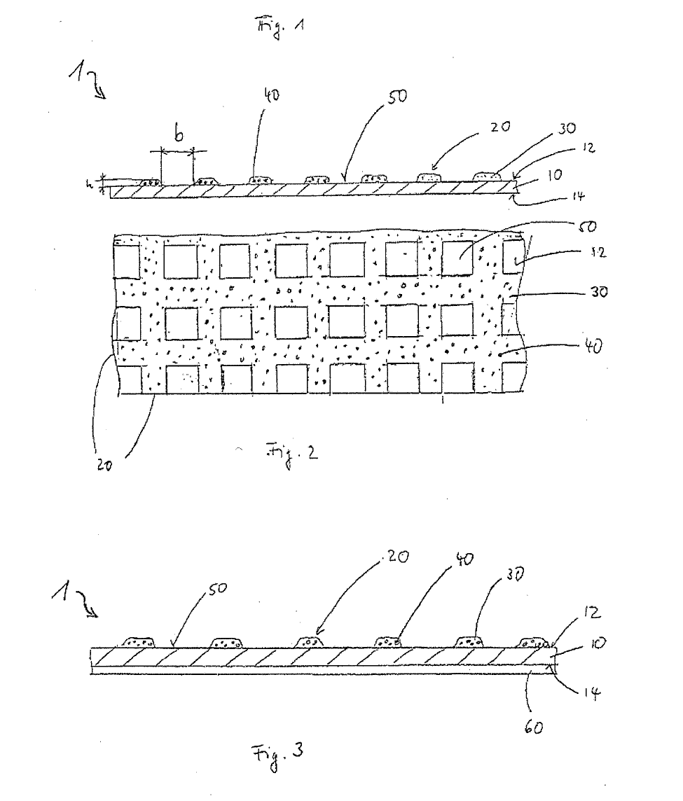

FIG. 1 shows a schematic cross-section through an embodiment of a material structure according to the invention,

FIG. 2 shows a top view of the embodiment of the material structure according to FIG. 1,

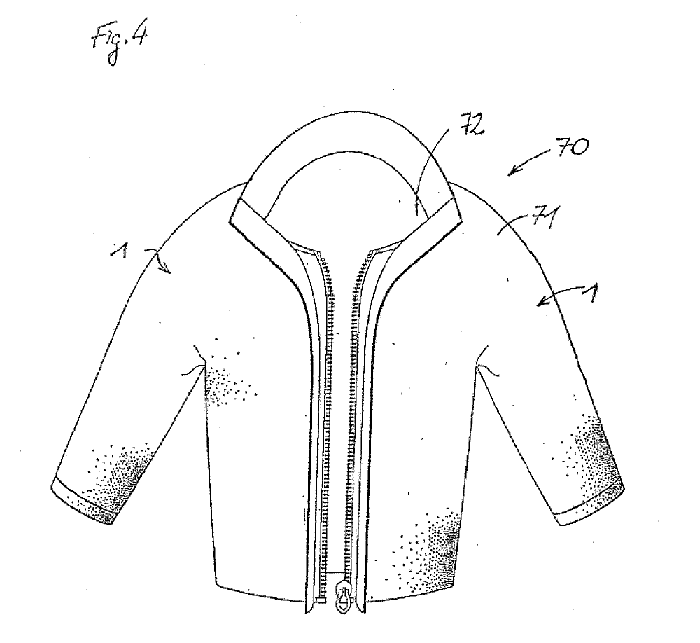

FIG. 3 shows a schematic cross-section through another embodiment of a material structure according to the invention,

FIG. 4 shows an example of a clothing article with a material structure according to the invention.

An embodiment of a material structure according to the invention is shown in FIG. 1. It contains a base structure 10 that has a first side 12 and a second side 14. The first side 12 is the outward-directed side of base structure 10, visible from the outside. When the material structure is used to produce a clothing article, side 12 in this case faces away from the body of the wearer of the clothing article. In this case, the opposite second side 14 faces the wearer of the clothing article and is accordingly not visible from the outside.

The base structure 10 contains, at least partially, a flame-retardant material produced from yarns or fibers, such as aramid yarns or aramid fibers, and/or yarns or fibers from viscose and/or polyimide. In one embodiment, the base structure 10 can be designed as aramid-yarn woven, warp-knit, knit-fabric, or aramid-nonwoven material. The base structure 10 can contain a textile material, in order to form a textile structure, with fire-proof material, such as a yarn or fiber material. It can be designed in a single-ply or multilayered form (for example, laminate structure). A woven or warp-knit fabric can be produced from aramid yarn, and so-called nonwoven materials can be produced from aramid fibers.

In the present embodiment example, the side 12 of base structure 10 visible from the outside is printed with a pattern formed by a material 30 with a fluorescent dye. As can be seen in conjunction with FIG. 2, the pattern 20 has open areas 50, through which the base structure 10 is visible through the surface of side 12. The open areas 50 can each include an area from 1 to 9 mm² in size. For example, side 12 of base structure 10 is printed with a pattern 20 with polymer material 30. The polymer material 30, for example, is a silicone, since this can be colored relatively well and enters into a good bond with the underlying textile of flame-retardant material. In this way, a material structure 1 can be produced that contains a non-combustible mixture of materials, so that material structure 1 can be used advantageously as an outer material of corresponding protective clothing.

The polymer material or silicone should have a viscosity that prevents running of the pattern on the base structure, and the viscosity should be such that the polymer material can be processed with printing methods, such as screen printing.

Pattern 20 can be applied, for example, by means of a screen-printing method, using a screen-printing template on the base structure 10. Pattern 20 can be designed as a grid pattern or dot pattern, and, in the present embodiment example, it is designed as a grid pattern. The pattern can also have any other desired shape or design, if the spacings of the pattern have the corresponding degree of coverage and the largest spacings within the pattern are no more than 3-4 mm. The grid pattern is formed, in particular, from two sets of parallel running strips, the strips of the different sets intersecting and the strips being formed on the base structure 10 with a height h of 20 to 870 μm. The open areas 50, in the present practical example, are designed approximately to be square, with a width, b, which is chosen accordingly, in order to obtain the desired surface of the open areas.

The fluorescent dye 40 added to material 30 contains color pigments that account for less than or equal to 30 weight percent of the pattern so produced. In particular, the fluorescent dye 40 has a fluorescent yellow, fluorescent red, and/or fluorescent orange (orange-red according to EN 471) dye. Side 12 of the base structure 10, visible to the outside, is dyed with a bright color, for example, a honey-yellow color, whereas pattern 20 is designed as a covering that is colored, grid-like coating with a fluorescent dye, as mentioned above. In combination, a color of material structure 1 is therefore produced that meets the requirements of EN 471 with respect to the signal colors fluorescent yellow, fluorescent orange-red or fluorescent red.

According to EN 471, which is hereby explicitly included in the disclosure content of the present application, section 5.1, Table 2, the color values must lie within the color areas defined by the corners of Table 2 and exceed the minimum luminance factor required in Table 2. The luminance factor of the orientation-dependent retro-reflecting material must correspond, on average, to the requirements of Table 2, determined by measurements, and the two rotation angles established in Section 7.3. The standard color-value fractions of the orientation-dependent, retro-reflecting material for both rotation angles established in section 7.3 must correspond to the requirements of Table 2.

All color values and brightness values present in the measurement surface are averaged to the Y (brightness) and x and y color coordinates. The luminance factor Y here corresponds to the luminance factor βₘᵢₙ according to EN 471 multiplied by 100. A spectrophotometer measures the color-value fractions x and y and the luminance factor Y of the material structure 1. The CM 508 photometer from Minolta, for example, is used as the spectrophotometer.

According to the invention, the requirements of EN 471 are achieved by applying a colored partial coating, in the present case in the form of a grid pattern, to the base structure 10. The base structure 10 itself, which can be designed, for example, as a textile containing aramid fibers or aramid yarns, is itself dyed with a bright color, as far as technically possible. By varying the free parameters color/brightness of the base structure 10, color/brightness of the patterned coating 20, and percentage coverage appropriately, any color can therefore be established, in principle. In order to achieve the requirements with respect to signal colors of EN 471, the coating should be designed to be covering and not transparent. The term “covering,” in this context, describes a continuous partial coating with a layer thickness between 20 and 80 μm, so that the color of the base structure does not show through in the area of the coating (covering).

For the case in which the coating has no or only limited water-vapor permeability, the lowest possible degree of coverage is sought.

A material structure 1 that meets the color requirement according to EN 471 has been achieved, for example, from a honey-yellow aramid textile with a fluorescent orange coating (degree of coverage about 60%, grid pattern). The coating was applied to the textile here by means of a screen-printing template. In addition to screen printing, other types of application can also be used, for example, to produce a pattern in the form of a dot pattern (dot print). In addition to silicone, all colorable pasty masses are also usable. Precoating with adhesive and then application of color pigments to it are also possible, in principle, in order to produce the pattern.

Since a smooth surface of material structure 1, based on the smooth surface properties of the pattern material, can be achieved with this technical solution, additional product properties, such as dirt repellence and abrasion resistance or a strong reduction of friction resistance on a wet surface can be achieved by means of the patterned coating 20. When used in a reversible clothing article, such as a reversible jacket, the coating could act as abrasion protection against clothing worn underneath. Abrasion resistance of the coating, as well as washing resistance of the coating, must be guaranteed.

In order to meet the requirements of EN 471 for signal color orange, the material structure has a luminance factor of Y≧40. For this purpose, it is proposed that the visible side 12 of the base structure 10 have a luminance factor of Y≧35. In this way, in combination with colored pattern 20, a situation is achieved, in which the luminance factor of Y≧40 is achieved for the entire material structure 1.

In order to meet the requirements for signal color red according to EN 471, it is proposed, in particular, that the visible side 12 of base structure 10 have a luminance factor of Y≧25. Here, the material structure 1 has a luminance factor of Y≧25.

In order to meet the requirements of EN 471 for signal color yellow, the visible side 12 of base structure 10 has a luminance factor of Y≧50. The material structure 1 overall has a luminance factor of Y≧70.

In all three embodiments, mentioned it is understood that the color-value fractions for the corresponding signal color are chosen corresponding to Table 2 (values x and y). For this purpose, corner points of a color square are set up from the x- and y-values of Table 2, whereby the color fractions of material structure 1 for the corresponding signal color must be situated within such a color square, in order to correspond to standard EN 471. The x- and y-values here represent x- and y-coordinates of a coordinate system spanned by the x- and y-axes to establish the standard color value fractions according to EN 471.

A material structure 1 that satisfies the color requirement according to EN 471 was achieved, for example, from a honey-yellow aramid textile (265 g/m²) with a grid-like fluorescent orange coating (silicone Elastosil LR 6200 from Wacker Chemie AG, degree of coverage about 60%, about 80 g/m²). The coating was applied to the textile by means of a screen-printing template at room temperature and cured in a furnace at 150° C. for 2 minutes.

The material structure thus formed is flame-retardant. According to European Standard EN 533 (1997), with the highest index of 3 that can be assigned with respect to flame propagation is reached. This means that no flame propagation, no hole formation, no burning drips, no afterglow, and no afterburning time greater than 2 seconds occurs during inflammation in the material. Therefore, the material according to the invention meets ISO 11613 (1999) for protective clothing for firefighters. A material for protective clothing for firefighters therefore can be made available that has a warning function and offers protection against heat and flames.

Another embodiment of the material structure 1 is shown in FIG. 3. According to this embodiment, the invisible side 14 of the base structure 10 is connected to a waterproof water-vapor-permeable functional layer 60. As an alternative or in addition, the functional layer 60 can also be designed as a wind-tight, water-vapor-permeable functional layer. In this context, all known types of such functional layers, for example, in the form of multilayer laminates, can be used, in principle. By providing the functional layer 60, an additional protective function material structure 1 can be achieved, so that, in addition to the above-mentioned protective properties, watertight protective clothing can also be achieved that has high wearing comfort, because of the water-vapor-permeability.

Two structures can occur, in particular: a) the base structure is joined (glued) to the functional layer and forms a two-layer or three-layer laminate; b) the functional layer hangs loosely in the form of a two-layer or three-layer laminate as a liner structure on the inside of the base structure and can be joined on the edges to the base structure.

Appropriate materials for the waterproof, water-vapor-permeable functional layer are especially polyurethane, polypropylene, and polyester, including polyether ester and laminates thereof, as described in the documents U.S. Pat. No. 4,725,418 and U.S. Pat. No. 4,493,870. However, expanded microporous polytetrafluoroethylene (ePTFE) is particularly preferred, as described, for example, in documents U.S. Pat. No. 3,953,566, as well as U.S. Pat. No. 4,187,390, and expanded polytetrafluoroethylene provided with hydrophilic impregnation agents and/or hydrophilic layers; see, for example, document U.S. Pat. No. 4,194,041. “Microporous functional layer” is understood to mean a functional layer whose average pore size is between about 0.2 μm and about 0.3 μm.

The pore size can be measured with a Coulter Porometer™, produced by Coulter Electronics, Inc., Hialeah, Fla., USA.

A functional layer is considered “waterproof;” optionally including the seams provided on the functional layer, if it guarantees a water-entry pressure of at least 1×10⁴ Pa. The functional layer material preferably guarantees a water-entry pressure of more than 1×10⁵ Pa. The water-entry pressure is then measured according to a test method in which distilled water, at 20±2° C., is applied to a sample of 100 cm² of the functional layer with increasing pressure. The pressure increase of the water is 60±3 cm H₂O per minute. The water-entry pressure then corresponds to the pressure at which water first appears on the other side of the sample. Details of the procedure are stipulated in ISO standard 0811 from the year 1981.

A functional layer is then considered “water-vapor-permeable,” if it has a water-vapor permeability Ret of less than 150 m²×Pa×W⁻¹. The water-vapor permeability is tested according to the Hohenstein skin model. This test method is described in DIN EN 31092 (02/94) and ISO 11092 (1993).

The term “air-tight (wind-tight)” means that the barrier layer or material web, in combination with the barrier layer, has an air permeability of less than 25 l/m²/s, in many embodiments less than 5 l/m²/s.

### Air Permeability:

In order to measure the air permeability of a material web (textile), a test device is used that can measure the air flow through the material web. The test examples are positioned between two rings, which results in a test area of 100 cm². Air is drawn through the test specimen at a constant pressure of 100 Pa. The air quantity that passes through the test specimen is measured and calculated in l/m²/s. The test method is described in EN ISO 9237.

FIG. 4 shows an example of a clothing article 70 in the form of an outer covering, for example, a warning or protective jacket, constructed with a material structure 1 according to the invention, as explained above. In particular, the first side 12 of base structure 10 forms an outer material 71 of the clothing article 70. In one embodiment, the clothing article 70 is reversible for use of the first side 12 of the base structure 10 as an outer material 71 or an inner material part 72 of the clothing article.

The term “flame-retardant,” in the context of this invention, means that the material structure has limited flame propagation. European standard EN 533 (1997) establishes performance requirements for limited flame propagation of materials, based on the results of tests according to EN 532 (corresponds to EN ISO 15025 (2003)). The performance is expressed by an index of limited flame propagation. Three performance stages are established:
In index-1 materials, no flame propagation occurs, hole formation can occur during flame contact.
In index-2 materials, no flame propagation occurs, hole formation does not occur on flame contact.
In index-3 materials, no flame propagation occurs, hole formation does not occur on flame contact, only limited afterburning occurs.

For firefighting protective clothing, a material with index 3 (corresponding to ISO 11613: 1999) is required.

The term “heat-resistant” means that the material withstands temperatures of more than 180° C. for a period of 5 minutes according to the oven test of EN ISO 15025 (2003).

The following standards are referred to in the present invention:

### EN 471 (2003): High-visibility Warning Clothing

EN 15025 (2003): Protective Clothing, Protection against Heat and Flame, Method of Test for Limited Flame Spread.

### ISO 11613 (1999): Protective Clothing for Firefighters—Laboratory Test Methods and Performance Requirements.

EN 533 (1997): Protective Clothing, Protection against Heat and Flame, Limited Flame Spread Materials and Material Assemblies.

### Example Material Structure

### Base Structure:

2-ply laminate, consisting of an aramid woven fabric with a basis weight of 205 g/m² and honey-yellow color, with a luminance factor Y=50. The aramid woven fabric is joined to a water-vapor-permeable and waterproof porous membrane of expanded PTFE (ePTFE), using a standard lamination method. The membrane was produced according to U.S. Pat. No. 3,953,566 and U.S. Pat. No. 4,187,390 and coated with a continuous layer of water-vapor-permeable hydrophilic polyurethane, as described in U.S. Pat. No. 4,194,041. To produce a 2-ply laminate, the aramid woven fabric is laminated on the ePTFE side of the coated membrane, using a spot-like polyurethane adhesive as described in U.S. Pat. No. 4,532,316. The laminate thus produced has a basis weight of 252 g/m² and is water vapor-permeable and waterproof.

The luminance factor and chromaticity of the textile layer of the laminate were determined from this laminate.

### Pattern Material:

Silicone LR6200 from Wacker Chemie AG, Germany, is mixed with 15% (with respect to the amount of silicone used) fluorescent pigments of fluorescent orange color obtained from Radiant Color Company, until the fluorescent pigments are uniformly distributed in the silicone. The viscosity of the silicone used is about 20,000 mPa/s.

### Method:

The dyed silicone is applied to the textile side of the 2-ply laminate by means of a screen-printing template. A grid structure is then formed, in which the individual strips have a height of about 50 μm. The grid structure on the base structure is cured in a furnace at a temperature of 160° C. for 2 minutes. The coated laminate (material structure) has a basis weight of 345 g/m².

### Test Methods:

The chromaticity (x, y) and minimum luminance factor (Y) were determined from the sample. The measurement was made with a Minolta CM 508C spectrophotometer.

| | | | | | Minimum |
|---|---|---|---|---|---|
| | | | | | luminance |
| | | | | | factor βmin |
| | x-coordinate for | y-coordinate for | Luminance | Luminance | according to |
| Sample | chromaticity | chromaticity | factor Y | factor β | EN 471 |
| 2-ply laminate | 0.47 | 0.44 | 50 | 0.50 | βmin (orange- |
| | | | | | red) = 0.40 |
| Coated | 0.588 | 0.368 | 50 | 0.50 | βmin (orange- |
| laminate | | | | | red) = 0.40 |

The uncoated 2-ply laminate has a sufficiently high luminance factor according to EN 471, but the chromaticity lies far outside the color coordinates for fluorescent orange according to EN 471. The coated laminate according to the invention, on the other hand, has a chromaticity within the color coordinates of EN 471. The coated laminate therefore has a fluorescent color according to EN 471.

The samples produced above were investigated for flame-resistance. For this purpose, the samples were subjected to a flame test. The sample was exposed for 10 seconds to surface inflammation according to ISO 15025 (2000) (corresponds to EN 532) and edge inflammation according to ISO 694. The sample withstood both flame exposures and showed no flame propagation and no hole formation (index 3).

### Test Methods:

### Chromaticity and Luminance Factor:

The chromaticity and luminance factor were measured according to point 7.3 of EN 471 (2003) with a spectrophotometer of the Minolta CM 508 brand. Each sample was measured, including the underlying materials processed during preparation. This means that a functional layer is arranged under each sample in the form of a 2-ply laminate liner, consisting of a membrane and textile support material. The membrane is directly below the sample. When measured with the spectrophotometer, the values for the x- and y-axes are interpreted to determine the chromaticity. The luminance factor Y is also measured. However, in EN 471, a minimum luminance factor βmin is stated for each color area. The ratio between βmin and Y is as follows: luminance factor Y corresponds to βmin×100.

1. A material structure, especially for the production of a material web for clothing, comprising:
a base structure that includes, at least partially, a flame-retardant material with a first side and a second side,
wherein at least the first side of the base structure is printed with a pattern that has open areas through which the surface of the base structure is visible,
wherein the pattern, has a material containing at least one fluorescent dye,
wherein the visible surface of the first side of the base structure, in combination with pattern, produces a material structure color that satisfies the requirements of European standard EN 471.

2. A material structure according to claim 1, wherein the first side of base structure has a light color.

3. A material structure according to claim 1, wherein pattern is designed as an opaquely dyed, partial coating.

4. Material structure according to claim 1, wherein the first side of base structure is dyed with a honey-yellow dye and the pattern is designed as an opaque fluorescent-orange partial coating, preferably with a degree of opaqueness of approximately 60% of the surface of base structure.

5. A material structure according to claim 1, wherein the pattern is designed as a grid pattern or dot pattern.

6. A material structure according to claim 1, wherein the pattern has a degree of opaqueness of approximately 20 to 80%, preferably 30 to 70%, especially 40 to 60% of the surface of base structure.

7. A material structure according to claim 1, wherein the flame-retardant material of the base structure features a yarn or fiber as chosen from the group comprising aramid, viscose, and polyimide.

8. A material structure according to claim 1, wherein the flame-retardant material of the base structure features a woven, warp-knit or knit made from aramid yarn or a nonwoven made from aramid fibers.

9. A material structure according to claim 1, wherein the first side of the base structure is designed as a visible front side of the material structure.

10. A material structure according to claim 1, wherein the surface of the first side of the base structure, in combination with pattern, produces a material structure color that meets the requirements of European standard EN 471 for the signal color yellow.

11. A material structure according to claim 10, wherein the material structure has a luminance factor of Y≧70.

12. A material structure according to claim 10, wherein the first side of the base structure has a luminance factor of Y≧50.

13. A material structure according to claim 1, in wherein the surface of the first side of the base structure, in combination with pattern, produces a material structure color that meets the requirements of European standard EN 471 for the signal color orange.

14. A material structure according to claim 13, wherein the material structure has a luminance factor of Y≧40.

15. A material structure according to claim 13, wherein the first side of base structure has a luminance factor of Y≧35.

16. A material structure according to claim 1, wherein the surface of the first side of the base structure, in combination with pattern, produces a material structure color that meets the requirements of European standard EN 471 for the signal color red.

17. A material structure according to claim 16, wherein the material structure has a luminance factor of Y≧25.

18. A material structure according to claim 1, wherein the first side of the base structure has a luminance factor of Y≧25.

19. A material structure according to claim 1, wherein the open areas of the base structure each encompass an area from 1 to 9 mm² in size.

20. A material structure according to claim 1, wherein the first side of base structure is printed with a pattern with polymer material.

21. A material structure according to claim 1, wherein the first side of the base structure is printed with a pattern from dyeable, paste-like material.

22. A material structure according to claim 20, wherein the polymer material is a silicone or polyurethane.

23. A material structure according to claim 1, wherein the first side of the base structure is formed with a pattern of color pigments that are applied to an adhesive coating.

24. A material structure according to claim 1, wherein the second side of the base structure is joined to a waterproof, water-vapor-permeable functional layer.

25. A material structure according to claim 1, wherein the second side of the base structure is joined to an air-tight, water-vapor-permeable functional layer.

26. A material structure according to claim 1, with a water-vapor-permeability greater than 50% of the water-vapor-permeability of the base structure.

27. A material structure according to claim 1, wherein the fluorescent dye stuff has a dye chosen from the group comprising fluorescent yellow, fluorescent red, and fluorescent orange.

28. A material structure according to claim 1, wherein the fluorescent dye stuff has color pigments that amount to less than or equal to 30 weight percent of the pattern.

29. A material structure according to claim 1, wherein the pattern is formed on the base structure with a height (h) of 20 to 80 μm.

30. A material structure according to claim 1, wherein the pattern is applied by means of a screen-printing method.

31. A material structure according to claim 1, wherein the material structure passes a flame test according to a test as established in ISO 6141.

32. A material structure according to claim 1, wherein the material structure is flame-retardant with a limited flame propagation according to the requirements of DIN EN 533 (1997).

33. A material structure according to claim 1, wherein the material meets the requirements of ISO 11613 (1999) for protective clothing for firefighters.

34. A clothing article with a material structure according to claim 1.

35. A clothing article according to claim 34, wherein the first side of base structure forms an upper material part of the clothing article.

36. A clothing article according to claim 34, wherein clothing article is reversible for use of the first side of base structure as an outer material part or an inner material part of the clothing article.
